(19) United States
(12) Patent Application Publication
(10) Pub. No.: US 2026/0283402 A1
(43) Pub. Date: Sep. 24, 2026

(54) ADJUSTABLE PIZZA OVEN

(71) Applicant: James A. Rose, Murrysville, PA (US)

(72) Inventor: James A. Rose, Murrysville, PA (US)

(21) Appl. No.: 19/576,511

(22) Filed: Mar. 24, 2026

Related U.S. Application Data
(60) Provisional application No. 63/776,388, filed on Mar. 24, 2025.

(51) Int. Cl. A47J 37/06; A47J 36/32; A47J 36/38

(52) U.S. Cl. CPC A47J 37/0658; A47J 36/32; A47J 36/38; A47J 2202/00

(57) ABSTRACT

The present invention is an adjustable cooking apparatus with radial heating of the cooking chamber and a movable chimney and/or ceiling.

### CROSS REFERENCE TO RELATED APPLICATIONS

This application claims the benefit under 35 U.S.C. § 119 of U.S. Provisional Application Ser. No. 63/776,388, filed on Mar. 24, 2025, which is incorporated herein by reference.

### BACKGROUND OF THE INVENTION

### Field of the Invention

The present invention is an adjustable cooking apparatus, e.g., for use in baking pizzas.

### BACKGROUND OF THE INVENTION

The present invention is an adjustable cooking apparatus with optional radial heating that solves several of the problems with existing outdoor cooking apparatuses generally, and specifically with outdoor pizza ovens. Conventional outdoor cooking apparatuses that use solid fuel (e.g. wood, charcoal, pellets, charcoal briquettes, coal) frequently do not provide adequate, proper, consistent, or customizable cooking temperatures. These conventional ovens heat the cooking surface to a high temperature but the air around and above the pizza (or food) is at a lower temperature, which results in uneven cooking of the pizza. This stems from the fact that, with existing pizza ovens, the heat is primarily below the pizza, so the bottom of the crust gets cooked well, but there is little to no heat directed to the top of the pizza to brown or crisp the cheese and toppings. One existing solution to this problem is to incorporate a second heat source in the top of the pizza oven to provide additional heat to the top of the pizza. However, this increases the manufacturing cost and complexity of these pizza ovens, creates additional parts that can break or malfunction, and increases the price to consumers. Cooking a pizza in many existing outdoor pizza ovens results in a crust that is finished baking before the cheese and toppings have browned or crisped. One embodiment of the present invention is an improved pizza oven that employs radial heating for a more even heating experience and a customizable cooking region that enables the user to control the temperature around the pizza, not just the temperature at the baking surface.

### BRIEF SUMMARY OF THE INVENTION

To facilitate understanding of the invention, the drawings and description illustrate preferred embodiments thereof, from which the invention, various embodiments of its structures, construction and method of operation, and many advantages, may be understood and appreciated. The drawings hereby are incorporated by reference.

One embodiment of the present invention is a cooking apparatus comprising the following: (i) at least one wall defining an interior volume; (ii) a roof connected to the at least one wall; (iii) a cooking chamber in the interior volume and having a cooking chamber top and a cooking chamber bottom; (iv) a cooking surface in the cooking chamber and near the cooking chamber bottom; (v) a heating chamber located in the interior volume, below the cooking chamber, and configured to provide heat to the cooking chamber; (vi) a plurality of apertures in the cooking chamber bottom to enable a radial heat flow from the heating chamber to the cooking chamber; and (vii) a movable chimney extending into the cooking chamber through the roof and configured to move vertically within the cooking chamber.

Another embodiment of the invention is a cooking apparatus comprising: (i) at least one wall defining an interior volume; (ii) a roof connected to the at least one wall; (iii) a cooking chamber within the interior volume and having a cooking chamber top and a cooking chamber bottom; (iv) a cooking surface in the cooking chamber and near the cooking chamber bottom; (v) a heating chamber located in the interior volume, below the cooking chamber, and configured to provide heat to the cooking chamber; (vi) a plurality of apertures in the cooking chamber bottom to enable a radial heat flow from the heating chamber to the cooking chamber; and (vii) a movable chimney extending into the cooking chamber through the roof and configured to move vertically within the cooking chamber.

In one embodiment of the present invention, the plurality of apertures is located around a perimeter of the cooking chamber bottom and surrounds the cooking surface. In one embodiment the apparatus includes a roof hole through which the chimney extends. One embodiment includes at least one door located in the wall to provide access to the cooking chamber. One embodiment includes a damper on the chimney. One embodiment further comprising a ceiling located near the cooking chamber top and through which the chimney extends. One embodiment includes a heat shield located beneath the cooking surface. One embodiment further comprising a hopper assembly which comprises a heat source located within the heating chamber. One embodiment further comprising a perimeter of insulation between the heat source and the wall in the heating chamber.

Any embodiment of the present invention can include a hopper assembly comprising some or all of the following: a hopper; an auger; a fan; and an igniter.

One embodiment further comprising a heat sensor to sense and control a temperature within the cooking chamber. One embodiment further comprising a thermostat to display the temperature within the cooking chamber. One embodiment of the apparatus is configured to be portable. For one embodiment the wall defines a cylindrical interior volume. For one embodiment a cooler air chamber is located between the insulation and the wall in the heating chamber, extending vertically through the heating chamber, and configured for the passage of cooler air through the heating chamber. In one embodiment, the ceiling is secured to the chimney and moves vertically with the vertical movement of the chimney.

One embodiment of the present invention is a cooking apparatus comprising: (i) at least one wall defining an interior volume; (ii) a roof connected to the at least one wall; (iii) a cooking chamber within the interior volume and having a cooking chamber top and a cooking chamber bottom; (iv) a cooking surface in the cooking chamber and near the cooking chamber bottom; (v) a heating chamber located in the interior volume, below the cooking chamber, and configured to provide heat to the cooking chamber; (vi) a plurality of apertures in the cooking chamber bottom to enable a radial heat flow from the heating chamber to the cooking chamber; and (vii) a movable ceiling located near the cooking chamber top and configured to move vertically within the cooking chamber.

### BRIEF DESCRIPTION OF THE SEVERAL VIEWS OF THE DRAWINGS

To facilitate understanding of the invention, the drawings and description illustrate preferred embodiments thereof, from which the invention, various embodiments of its structures, construction and method of operation, and many advantages, may be understood and appreciated. The drawings are incorporated by reference.

FIG. 1 is a cross-sectional, top-down view of a pizza sitting on the cooking surface of one embodiment of the present invention with radial heat around the perimeter;

FIG. 2 illustrates one embodiment of a cooking apparatus according to the present invention;

FIGS. 3A and 3B are two cross-sectional views of a cooking apparatus with a movable chimney according to one embodiment of the present invention;

FIG. 4A is a cross-sectional view of another embodiment of a cooking apparatus according to one embodiment of the present invention with additional, top-down, cross-sections illustrated in FIG. 4B (the section labeled B in FIGS. 4A) and 4C (the section labeled A in FIG. 4A); and

FIGS. 5A through 5D are various configurations of movable chimneys and ceilings within the cooking chamber of different embodiments of the present invention.

### DETAILED DESCRIPTION OF THE INVENTION

The following describes example embodiments in which the present invention may be practiced. This invention, however, may be embodied in many ways, and the description provided herein should not be construed as limiting in any way. Among other things, the following invention may be embodied as systems, methods, or devices. The following detailed descriptions should not be taken in a limiting sense. The accompanying drawings are hereby incorporated by reference.

The phrases “in some embodiments”, “in one embodiment”, “in various embodiments”, “according to various embodiments”, “in the embodiments shown”, “in other embodiments”, and the like generally mean the particular feature, structure, or characteristic following the phrase is included in at least one embodiment of the present invention and may be included in more than one embodiment of the present invention. In addition, such phrases do not necessarily refer to the same embodiments or to different embodiments.

If the specification states a component, element, part, or feature “may,” “can,” “could,” or “might” be included or have a characteristic, that particular component or feature is not required to be included or have the characteristic.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the figures. However, it is to be understood that the invention may assume alternative orientations, variations, and step sequences, except where expressly specified to the contrary. It also is to be understood that the specific devices and processes illustrated in the attached drawings and described in this specification are simply exemplary embodiments of the invention. Hence, specific dimensions and other physical characteristics related to the embodiments disclosed herein are not to be considered as limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the invention, for example.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

It is to be understood that the invention may assume alternative variations and step sequences, unless specified to the contrary. It also is to be understood that the specific devices and processes illustrated in the attached drawings and described in this specification are simply exemplary embodiments of the invention. Hence, specific dimensions and other physical characteristics related to the embodiments disclosed are not to be limiting.

The present invention is an adjustable cooking apparatus 1 that can be used for cooking a wide variety of foods 200. For ease of discussion, the various embodiments of adjustable cooking apparatus 1 will be discussed in the context of baking a pizza 200. However, it will be obvious to one skilled in the art that the various embodiments of cooking apparatuses 1 of the present invention can be used to cook a wide variety of foods 200 and many foods 200 beyond pizza 200 can benefit from the customizable design of the present invention. Additionally, the present invention is described for use outdoors, and most embodiments are configured for outdoor use. However, other embodiments can be configured for sheltered use in environments that are not fully “outdoors”. Most embodiments are configured to be portable or movable.

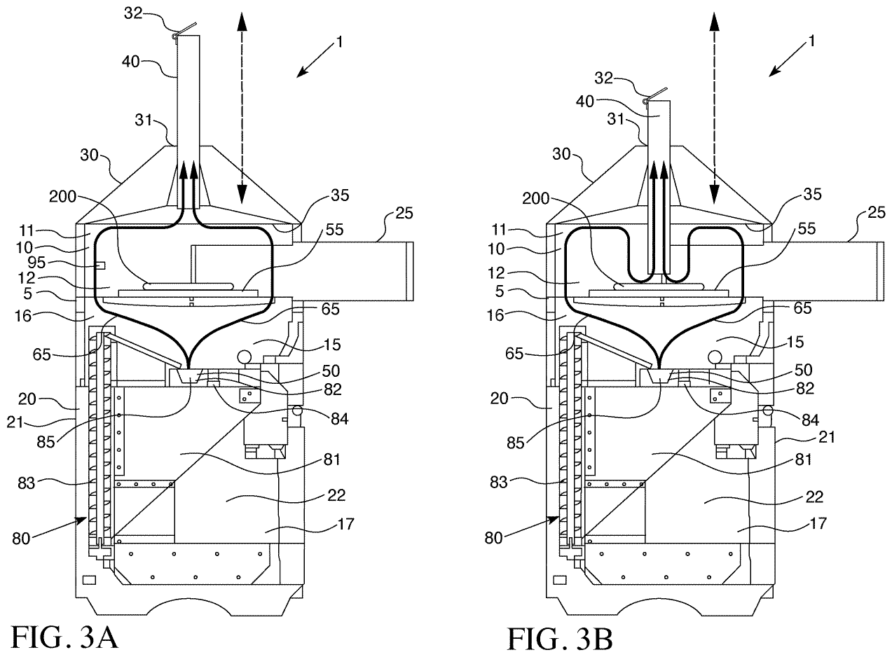

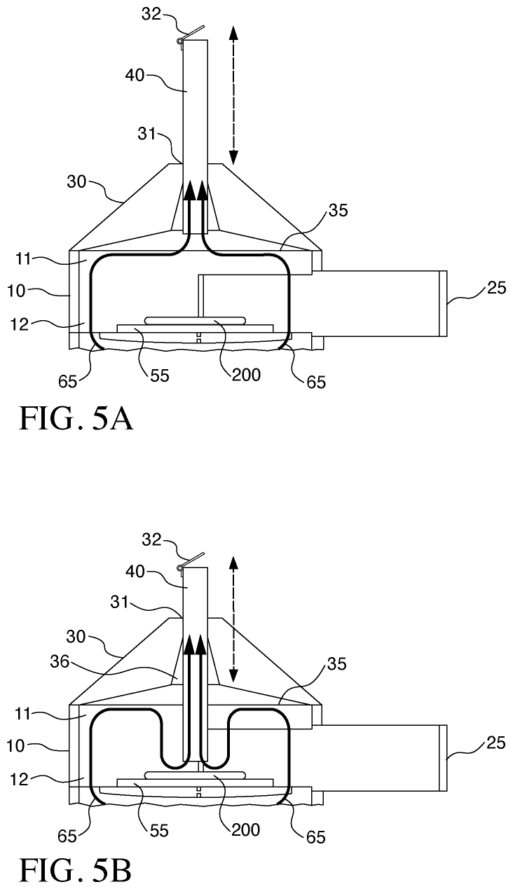

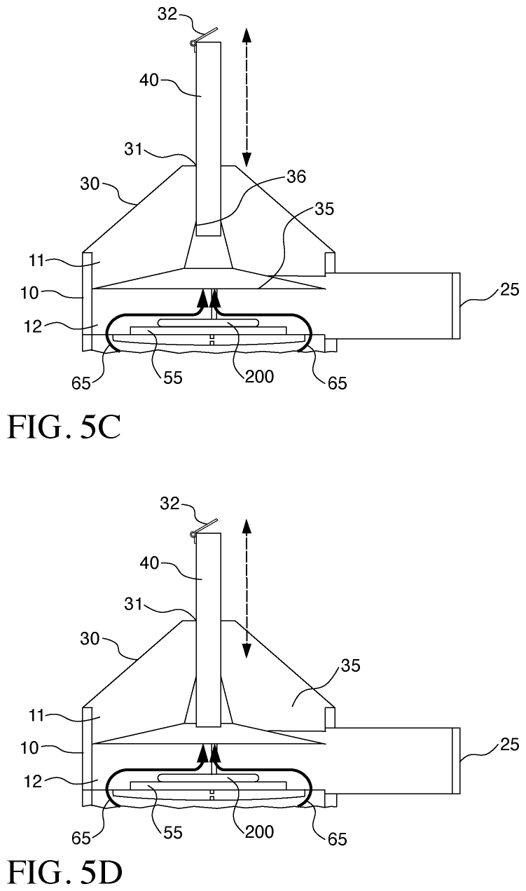

Various embodiments of the present invention are directed to a cooking apparatus 1 that has a movable chimney 40 (see FIGS. 3A, 3B and 5B). The movable chimney 40 allows for the flow of the hot air/smoke/gasses (collectively herein “hot air 65” or “heat 65”) to be directed above the food 200 to provide for a higher temperature above the food 200 and faster cooking of the top of the food 200. Other embodiments are directed to a cooking apparatus 1 that has a movable ceiling 35 (see FIG. 5C), while still other embodiments are directed to a cooking apparatus 1 that has both a movable chimney 40 and a movable ceiling 35 (see FIG. 5D.)

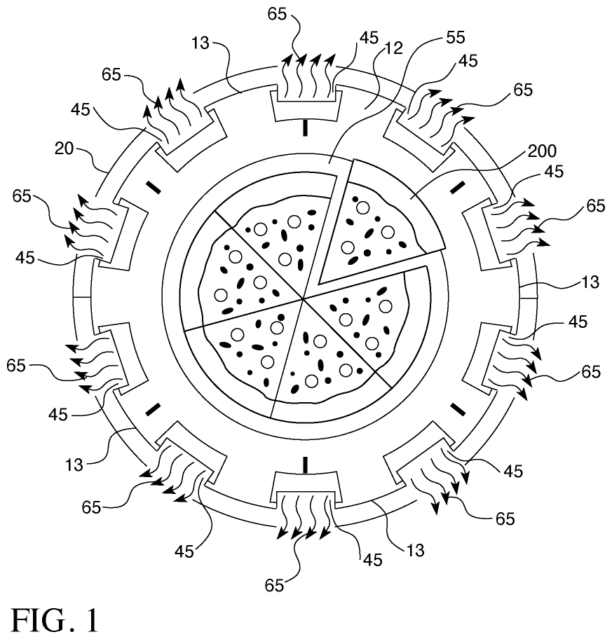

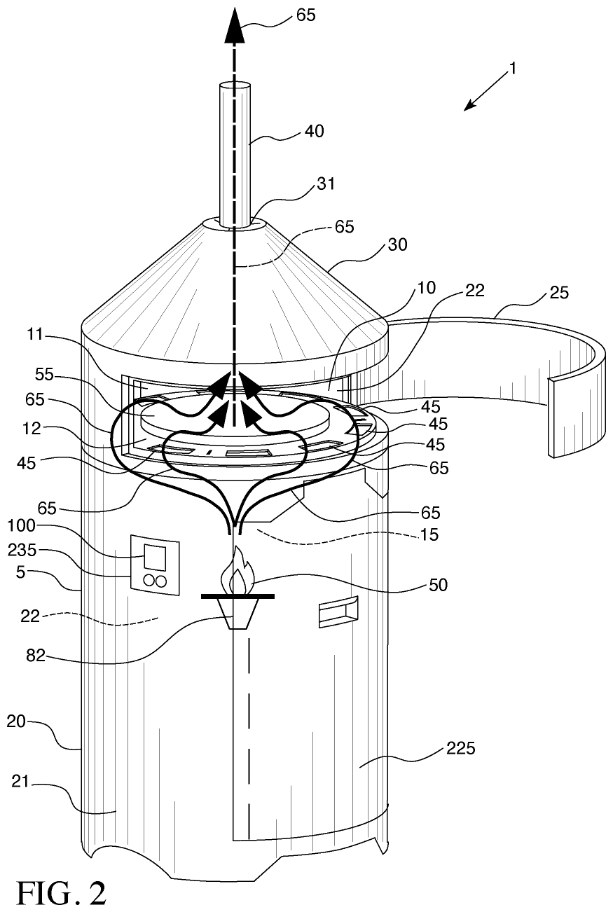

Certain of the embodiments of the present invention have apertures 45 located around perimeter 13 of the cooking chamber bottom 12 and/or around the periphery of the cooking surface 55 to facilitate the radial flow of heat 65 from the lower heating chamber 15 into the upper cooking chamber 10 (see FIGS. 1, 2, and 4B). These arrangements of apertures 45 create convection heating within the cooking chamber 10 (see FIGS. 2, 3A through 4B). This provides for more uniform, consistent, and controllable temperatures within the upper cooking chamber 10, which enables more even cooking of food 200 in the upper cooking chamber 10.

The present invention encompasses various embodiments of a cooking apparatus 1 In one embodiment, the cooking apparatus 1 has a body 5 that defines an interior volume 22. Body 5 is defined by at least one wall 20, which has an exterior 21. Wall 20 defines an interior volume 22 of the cooking apparatus 1. The interior volume 22, in most embodiments, is divided into upper cooking chamber 10 and lower heating chamber 15. Exterior 21 of one embodiment is shown in FIG. 2. The embodiment in FIG. 2 has a cylindrical exterior 21 with a door 25 that opens to provide access to the interior volume 22 (or specifically, in FIG. 2, to the upper cooking chamber 10) of the cooking apparatus 1 and is sized and shaped to enable easy access to the food 200 in the cooking chamber 10. As illustrated in FIG. 2, this embodiment has a lower heating chamber 15 and an upper cooking chamber 10. Also illustrated in FIG. 2 is an access panel 225 (or an access door or drawer, collectively referred to herein as a “access panel 225”) to enable the user to access the heating chamber 15. A vertically movable chimney 40 exits the upper cooking chamber 10 through a hole 31 in the roof 30.

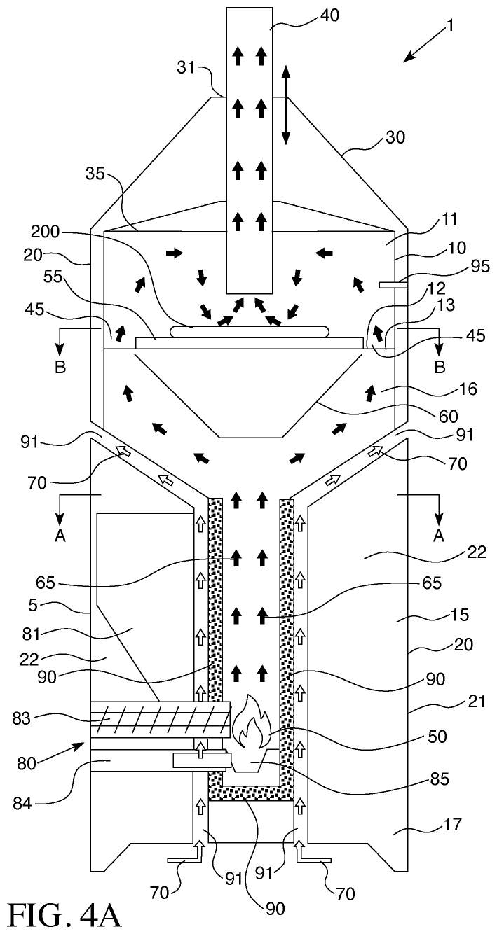

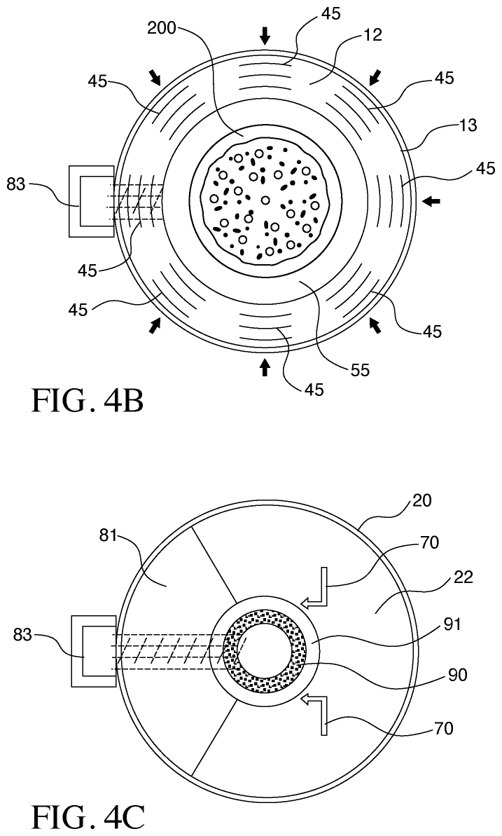

The lower heating chamber 15 can have a variety of configurations, examples of which are illustrated in FIGS. 3A, 3B, 4A, and 4C. The lower heating chamber 15 has a heating chamber top 16, which is closer to the upper cooking chamber 10, and a heating chamber bottom 17, which is farther away from the upper cooking chamber 10 and closer to whatever surface the cooking apparatus 1 sits upon. FIGS. 3A and 3B illustrate one configuration of a hopper assembly 80. It will be understood by one skilled in the art that any of a variety of hopper assemblies 80 can be used with the various embodiments of a cooking apparatus 1 of the present invention. As a non-limiting example, a hopper assembly 80 can be comprised of a hopper 81 (which holds unheated fuel pellets), a firepot 82 (generically referred to herein as a “heat source 50”) located in the lower heating chamber 15 (in which the pellets burn), an auger 83 (which moves the pellets from the hopper 81 to the firepot 82), an optional fan 84 to circulate air 65 for combustion, and an igniter 85 (to ignite the pellets). Hopper assembly 80 configurations work with solid forms of fuel (e.g. wood, charcoal, pellets, charcoal briquettes, coal). Other embodiments of the present invention can be modified to accommodate gas fuel, such as propane, as is common with outdoor cooking devices. All of these various types of fuel function as a heat source 50 in the various embodiments of cooking apparatuses 1. Finally, other embodiments of the present invention can be configured to burn wood in non-pellet forms. Most embodiments incorporate at least one type of heat source 50 into the heating chamber 15 to produce hot air 65 that heats the cooking chamber 10.

FIGS. 4A and 4C illustrate an alternative embodiment of a lower heating chamber 15, which incorporates a standard pellet hopper 81, augur 83 (with motor), igniter 85, and firepot 82. In this embodiment, the firepot 82 is surrounded by a column of insulation 90. The insultation 90 helps to maximize the amount of heat 65 from the firepot 82 that is funneled to the cooking chamber 10 and lessens the loss of heat 65 within the lower heating chamber 15. As illustrated in FIGS. 4A and 4C, in one embodiment, the insulation 90 is surrounded by a cooler air chamber 91which facilitates the movement of cooler air 70 entering through the bottom 17 of the heating chamber 15 and exits closer to the cooking chamber 10 or closer to the heating chamber top 16. Again, the incorporation of a cooler air chamber 91 to move cooler air 70 ensures that the lower heating chamber 15 stays cool to the touch to lessen the chance of burns to the user.

Also, within the cylindrical body 5 of the embodiment illustrated in FIG. 4A is an upper cooking chamber 10 having a cooking chamber top 11 and a cooking chamber bottom 12. Along the top 11 of the cooking chamber 10 is a ceiling 35. Near the bottom 12 of the cooking chamber 10 is a cooking surface 55. As illustrated in FIG. 4B, around the periphery of the cooking surface 55 are a plurality of apertures 45, which allow the flow of heat/air/gasses 65 from the lower heating chamber 15 into the upper cooking chamber 10 around the cooking surface 55. Also, in the embodiment illustrated in FIG. 4A, is a heat shield 60 is located below the cooking surface 55. This heat shield 60 further regulates the amount of heat 65 that is absorbed by the cooking surface 55 and better balances the heat 65 within the cooking chamber 10 and the heat 65 absorbed by the cooking surface 55 to facilitate more even cooking of the food 200. In one embodiment, the heat shield 60 is made from steel (or another heat-appropriate metal) and allows heat 65 to be directed around the cooking surface 55. In one embodiment, the heat shield 60 has a variety of holes in it, which holes allow for heating of the bottom of the cooking surface 55 by radiant and/or convective heat transfer. Various configurations of heat shield 60 enable heating of the bottom of the food 200 by increasing the heat absorbed by the cooking surface 55.

In one embodiment, the chimney 40 (as illustrated in FIG. 4A) is adjustable vertically, to control the amount of heat 65 directed at the top surface of the food 200 on the cooking surface 55 and/or to control the circulation of hot air 65 within the cooking chamber 10. The heat, smoke, warm air, and gases 65 within the cooking chamber 10 vent out of this chimney 40. In another embodiment, the vertical adjustment of the chimney 40 is configured to be controllable while food 200 is cooking in the apparatus 1. These same options apply to those embodiments that have a movable ceiling 35 and a movable ceiling 35 with a movable chimney 40. The movement of any configuration of chimney 40 and ceiling 35 can be achieved while the food 200 is cooking to enable customization of the cooking environment during the cooking process.

On top of the cylindrical body 5 is a roof 30 with a hole 31 near its center through which the chimney 40 emerges (see FIGS. 3A, 3B, 4A and 5A-5D, in which the roof 30 is conical in shape.) Various embodiments of the present invention can be configured to have an adjustable damper 32 on the chimney 40. While the figures of the present invention illustrate a cylindrical exterior 21 shape for an outdoor cooking device, the present invention encompasses any size, shape, and external body 5 that is configured to define an internal volume 22 and to house a lower heating chamber 15, an upper cooking chamber 10, a cooking surface 55, a movable chimney 40, and/or the additional elements of the present invention outlined herein. Often, but not always, the shape of the roof 30 is dictated in part by the shape of the external body 5. Non-limiting examples of those alternatives include rectangular-shaped cooking apparatuses 1, flat roofs 30, and/or chimneys 40 that exit through different locations in the roof 30.

FIGS. 3A and 3B illustrate the interior 22 of one embodiment of an outdoor cooking apparatus 1 of the present invention. As shown in FIGS. 3A and 3B, the outdoor cooking apparatus 1 has an upper cooking chamber 10 having a top 11, a bottom 12, and at least one side. The top 11 of the upper cooking chamber 10 is near the ceiling 35 and the bottom 12 of the upper cooking chamber 10 is near the border between the upper 10 and lower chamber 15. There is a cooking surface 55 within the upper cooking chamber 10 and near the bottom 12 of the upper cooking chamber 10. For various embodiments of the present invention, the cooking surface 55 and bottom 12 of the upper cooking chamber 10 can be the same surface or they can be two separate surfaces often, but not always, in relatively close proximity to one another. This cooking surface 55 can be any food-safe surface, such as a pizza or baking stone, a food-safe metal surface, a grate, or it can be an interchangeable surface (for example, an interchangeable grate and pizza stone). Beneath the upper cooking chamber 10 is a lower heating chamber 15 that is configured to provide heat to the upper cooking chamber 10. In one embodiment of the present invention, the lower cooking chamber 10 contains at least one heat source 50 (such as a firepot 82 to burn solid fuel 86). In another embodiment, this heating element is a fuel-fed flame located below the cooking surface 55 (such as a gas-fed flame). FIGS. 3A and 3B illustrate an embodiment with a movable chimney 40 that moves up and down (vertically). Varying the vertical height/location of the chimney 40 within the cooking chamber 10 results in different hot air 65 flows within the upper cooking chamber 10 and different temperatures of the air 65 directly above the food 200 within the upper cooking chamber 10. More specifically, moving the chimney 40 enables the user to adjust the cooking chamber 10 to bring the hottest gas temperatures closer to the food 200 before the hot air 65 travels up to and through the chimney 40.

Various embodiments of the present invention are configured with different mechanisms to adjust the height or location of the chimney 40. In one embodiment, the chimney 40 of the outdoor cooking apparatus 1 is configured to be movable manually and then secured in place (for example, with a clamp). Another embodiment is configured to have a wheel mechanism to adjust the elevation of the chimney 40. For that embodiment, the wheel rotates via a rack and pinion. Alternately, another embodiment is configured so that the chimney 40 has a coarse thread on the exterior of the chimney 40 that mates with the roof hole 31 enabling the chimney 40 to be rotated to move up and down. Other mechanisms known to one skilled in the art can be used, as well.

Different embodiments of the present invention vary in their incorporation of a movable chimney 40 and/or a movable ceiling 35. Some embodiments are shown in FIGS. 5A through 5D. FIG. 5A shows one embodiment of an apparatus 1 in which the chimney 40 and ceiling 35 are at their highest vertical position, which results in the greatest distance between the cooking surface 55 and the chimney 40 and ceiling 35. FIG. 5B illustrates an embodiment of an apparatus 1 having only a movable chimney 40, which moves vertically through a roof hole 31 and a ceiling hole 36. As illustrated in FIG. 5B, the chimney 40 can move vertically down closer to or farther away from the cooking surface 55, which changes the heat 65 flow in the upper cooking chamber 10 and, thus, changes the temperature above the cooking surface 55 or the food 200. Other embodiments incorporate only a vertically adjustable ceiling 35, such as that illustrated in FIG. 5C. FIG. 5C illustrates an apparatus 1 having a stationary chimney 40 and a vertically movable ceiling 35 that can be positioned closer to or farther away from the cooking surface 55 and the food 200 to change the flow of heat 65 and the temperature in the cooking chamber 10 and around the food 200. Still other embodiments incorporate both a movable ceiling 35 and a movable chimney 40, such as that illustrated in FIG. 5D. In FIG. 5D, the chimney 40 and the attached ceiling 35 move together to change the flow of heat 65 and the temperature in the cooking chamber 10, and more specifically, directly above the cooking surface 55 and the food 200. In various embodiments, the chimney 40 and ceiling 35 can be configured to move as one unit or independent of one another.

Various embodiments of the present invention can be configured with optional accessories or capabilities. For example, one embodiment of the present invention includes at least one heat sensor 95 to sense the heat within the upper cooking chamber 10. Another embodiment of the present invention is wired so that the internal temperature of the cooking chamber 10 is visible to the user of the cooking apparatus 1.

Various embodiments of the present invention are configured to provide radial heat flow to the upper cooking chamber 10. FIG. 1 illustrates one embodiment in which the bottom 12 of the upper cooking chamber 10 has a plurality of apertures 45 around its perimeter 13 that permit the heat from the lower heating chamber 15 to flow directly into the upper cooking chamber 10. FIG. 4B illustrates an alternative embodiment of apertures 45 for radial heating of the cooking chamber 10. This is distinguishable from many pizza ovens currently available in which the bottom 12 or cooking surface 55 is a solid surface and the upper cooking chamber 10 is heated only from the heat coming off of the heated bottom 12 or the heated cooking surface 55.

FIG. 2 illustrates a side view of the radial heating. The heat 65 is generated within the lower heating chamber 15 and flows up through the apertures 45 and into the upper cooking chamber 10. FIGS. 3A and 3B illustrate the variation in the flow of heat within the upper cooking chamber 10 when the height of the chimney 40 changes. In FIG. 3A, the heat flows around the food 200 on the cooking surface 55 creating an even, but less intense heat directly above the food 200. By lowering the chimney 40, as shown in FIG. 3B, the heat that is traveling through the apertures 45 is compressed and intensified right above the food 200 (which are located on the cooking surface 55). Increasing the temperature right above the food 200 causes the top of the food 200 to cook faster and, at least for pizza, to cook at a rate more in alignment with the cooking of the crust. Therefore, this results in a pizza with an evenly cooked top and bottom.

It will be obvious to one skilled in the art that there are a variety of acceptable and known materials from which the various components of the apparatus 1 can be made. As some non-limiting examples though, Body 5 of the cooking apparatus 1 and the components exposed to heat 65 can be made from steel, stainless steel, or aluminum. Cooking surface 55 can be ceramic or steel. Other accents and smaller parts can be made from polymers, brass, wood, or other well-known materials. Also known to one skilled in the art are the various components that are common to grills, smokers, pizza ovens, and other outdoor food cooking devices to sense, control, adjust, and maintain the heat and temperature in the devices, such as incorporation of a control panel 235 and a thermostat 100 (examples of which are shown in FIG. 2.) As with other related technologies, the control panel 235 can be configu1red to process the various inputs (such as from the heat sensor 95 and the thermostat 100) and control the various components and functions of the cooking apparatus 1.

While the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

What is claimed is:

1. A cooking apparatus comprising:
at least one wall defining an interior volume;
a roof connected to the at least one wall;
a cooking chamber within the interior volume and having a cooking chamber top and a cooking chamber bottom;
a cooking surface in the cooking chamber and near the cooking chamber bottom;
a heating chamber located in the interior volume, below the cooking chamber, and configured to provide heat to the cooking chamber;
a plurality of apertures in the cooking chamber bottom to enable a radial heat flow from the heating chamber to the cooking chamber; and
a movable chimney extending into the cooking chamber through the roof and configured to move vertically within the cooking chamber.

2. The cooking apparatus of claim 1, wherein the plurality of apertures is located around a perimeter of the cooking chamber bottom and surrounding the cooking surface.

3. The cooking apparatus of claim 1, further comprising a roof hole through which the chimney extends.

4. The cooking apparatus of claim 1, further comprising at least one door located in the wall to provide access to the cooking chamber.

5. The cooking apparatus of claim 1, further comprising a damper on the chimney.

6. The cooking apparatus of claim 1, further comprising a ceiling located near the cooking chamber top and through which the chimney extends.

7. The cooking apparatus of claim 1, further comprising a heat shield located beneath the cooking surface.

8. The cooking apparatus of claim 1, further comprising a hopper assembly which comprises a heat source located within the heating chamber.

9. The cooking apparatus of claim 8, further comprising a perimeter of insulation between the heat source and the wall in the heating chamber.

10. The cooking apparatus of claim 8, wherein the hopper assembly also comprises:
a hopper;
an auger;
a fan; and
an igniter.

11. The cooking apparatus of claim 1, further comprising a heat sensor to sense and control a temperature within the cooking chamber.

12. The cooking apparatus of claim 11, further comprising a thermostat to display the temperature within the cooking chamber.

13. The cooking apparatus of claim 1, wherein the apparatus is configured to be portable.

14. The cooking apparatus of claim 1, wherein the wall defines a cylindrical interior volume.

15. The cooking apparatus of claim 9, further comprising a cooler air chamber located between the insulation and the wall in the heating chamber, extending vertically through the heating chamber, and configured for the passage of cooler air through the heating chamber.

16. The cooking apparatus of claim 6, wherein the ceiling is secured to the chimney and moves vertically with the vertical movement of the chimney.

17. A cooking apparatus comprising:
at least one wall defining an interior volume;
a roof connected to the at least one wall;
a cooking chamber within the interior volume and having a cooking chamber top and a cooking chamber bottom;
a cooking surface in the cooking chamber and near the cooking chamber bottom;
a heating chamber located in the interior volume, below the cooking chamber, and configured to provide heat to the cooking chamber;
a plurality of apertures in the cooking chamber bottom to enable a radial heat flow from the heating chamber to the cooking chamber;
a chimney extending into the cooking chamber through the roof; and
a movable ceiling having a ceiling hole that circles the chimney, which movable ceiling is located near the cooking chamber top and configured to move vertically within the cooking chamber.

18. The apparatus of claim 17, further comprising a heat shield located beneath the cooking surface.

19. The apparatus of claim 17, wherein the heating chamber comprises a heating chamber bottom and the firepot is located near the heating chamber bottom.

20. The apparatus of claim 18, further comprising a movable chimney extending from the cooking chamber through a hole in the roof.
